(19) United States
(12) Patent Application Publication
(10) Pub. No.: US 2026/0058040 A1
(43) Pub. Date: Feb. 26, 2026

(54) THERMISTOR ELEMENT AND METHOD FOR MANUFACTURING THE SAME

(71) Applicant: MITSUBISHI MATERIALS CORPORATION, Tokyo (JP)

(72) Inventors: Takehiro Yonezawa, Naka-shi (JP); Yusuke Hosokawa, Naka-shi (JP); Kazutaka Fujiwara, Naka-shi (JP); Noriaki Iwashiro, Chichibu-gun (JP); Shota Wakana, Chichibu-gun (JP); Hiroki Sato, Chichibu-gun (JP)

(73) Assignee: MITSUBISHI MATERIALS CORPORATION, Tokyo (JP)

(21) Appl. No.: 19/105,505

(22) PCT Filed: Apr. 5, 2023
(86) PCT No.: PCT/JP2023/014072

§ 371 Date: Feb. 21, 2025

(30) Foreign Application Priority Data
Aug. 25, 2022 (JP) 2022-134195

(51) Int. Cl. H01C 7/00; H01C 17/28

(52) U.S. Cl. CPC H01C 7/008; H01C 17/281

(57) ABSTRACT

Provided are a thermistor element including a conductive intermediate layer that can stably exist even at high temperature, and a method for manufacturing the same. The thermistor element includes: a thermistor element body 2 which contains an oxide thermistor material whose crystal structure is a perovskite-type; a conductive intermediate layer 3 formed on the thermistor element body; and an electrode layer 4 formed on the conductive intermediate layer, wherein the conductive intermediate layer is a composite oxide containing Mn. The method for manufacturing the thermistor element includes an intermediate layer forming step of forming a conductive intermediate layer of a composite oxide containing Mn on a thermistor element body, and an electrode layer forming step of forming an electrode layer on the conductive intermediate layer, wherein in the intermediate layer forming step, a Mn-containing dispersion is applied onto the thermistor element body, and dried to form a temporary intermediate layer.

### TECHNICAL FIELD

The present invention relates to a thermistor element suitable for a temperature sensor, a protective circuit of an electronic device, and the like, and a method for manufacturing the same.

### BACKGROUND ART

As a part of global warming countermeasures, with the rapid expansion of the EV market in recent years, high-speed charging, high output of the motor, and with the increase in the driving temperature of the IGBT power module accompanying these, a thermistor that monitors the temperature is also required to operate at a higher temperature.

In a thermistor material having a spinel structure based on Mn, Co, or the like, which is a thermistor material currently most generally used, a B constant, which is a temperature count of the thermistor, is as large as about 3000 to 4000.

Therefore, in the thermistor material having a spinel structure, the change in the resistance value with respect to the temperature is too large, and the resistance value is too low at a high temperature with the characteristics suitable for low temperature, so that an accurate temperature cannot be detected. In addition, there is a problem that the resistance value at a low temperature is too high with the characteristics suitable for high temperature, so that an accurate temperature cannot be detected.

Therefore, as in Patent Literature 1, it has been proposed to achieve a low B constant and adjustment of a resistance value by using a perovskite-based thermistor material having a small B constant and forming a composite structure with an insulating material.

However, since the composite structure of the insulating material and the thermistor material is formed, the thermistor material exposed at an electrode interface is small, and there is a problem that an electrical contact with an electrode is reduced.

In particular, in a generally used method of printing and baking a noble metal paste, a glass frit is used, and the molten glass frit is interposed between the thermistor element body and the electrode to ensure adhesion, but there are very few direct contacts between the electrode and the thermistor element body.

As described above, it is not possible to obtain good electrical characteristics by joining structures having few electrical contacts. In view of this problem, it is considered effective to form a conductive intermediate layer at the interface between the thermistor element body and the electrode as in Patent Literature 2. In the thermistor element of Patent Literature 2, the conductive intermediate layer has an agglomerated structure of RuO₂ grains in electrical contact with each other, and SiO₂ is interposed in a gap of the agglomerated structure.

### CITATION LIST

### Patent Literature

Patent Literature 1: JP 4183666 B1

Patent Literature 2: JP 6365603 B1

### SUMMARY OF INVENTION

### Technical Problem

The conventional technique described above has the following problems.

That is, in the thermistor element described in Patent Literature 2, RuO₂ sublimates at about 900° C., thus it has been difficult to use in a noble metal electrode such as a Pt electrode that needs to be baked at a high temperature using a noble metal paste such as a Pt paste.

The present invention has been made in view of the above problems, and an object thereof is to provide a thermistor element including a conductive intermediate layer that can stably exist even at a high temperature, and a method for manufacturing the same.

### Solution to Problem

In order to solve the above problems, the present invention adopts the following configuration. That is, the thermistor element according to a first invention includes a thermistor element body which contains an oxide thermistor material whose crystal structure is a perovskite-type; a conductive intermediate layer formed on the thermistor element body; and an electrode layer formed on the conductive intermediate layer, wherein the conductive intermediate layer is a composite oxide containing Mn.

In this thermistor element, since the conductive intermediate layer is a composite oxide containing Mn (manganese), the crystal structure of the composite oxide containing Mn is close to that of the perovskite-type thermistor element body, so that adhesion of the conductive intermediate layer is improved, and the conductive intermediate layer can stably exist even at a high temperature. In particular, since the conductive intermediate layer contains Mn, high adhesion to an electrode layer formed of a noble metal can be obtained, and even when the electrode layer is formed of a noble metal or the like that needs to be baked at a high temperature, the conductive intermediate layer can stably exist even after baking. Also, when the oxide thermistor material constituting the thermistor element body contains an oxide containing Mn, the adhesion to the conductive intermediate layer which is a composite oxide containing Mn is further improved.

Note that the composite oxide refers to a substance expressed as an oxide of two or more kinds of elements (or the same elements having different oxidation numbers).

In a thermistor element according to a second invention is, in the first invention, the composite oxide further contains Y.

That is, in this thermistor element, since the composite oxide further contains Y (yttrium), Mn and Y react with each other to form a composite oxide, so that higher conductivity can be obtained. Also, when the oxide thermistor material constituting the thermistor element body contains an oxide containing Y, the adhesion to the conductive intermediate layer containing Y is further improved.

In a thermistor element according to a third invention, in the first or second invention, the composite oxide further contains one or more of Ca, Sr, Ba, and La.

That is, in this thermistor element, since the composite oxide further contains one or more of Ca (calcium), Sr (strontium), Ba (barium), and La (lanthanum), the substitution of Y in the composite oxide with at least one of Ca, Sr, Ba, and La reduces lattice distortion to improve electron mobility in the case of La, and increases carriers in the cases of Ca, Sr, and Ba, so that high conductivity can be obtained.

In a thermistor element according to a fourth invention, in any one of the first to third inventions, the electrode layer contains Pt.

That is, in this thermistor element, even in a Pt electrode in which the electrode layer contains Pt, that is, a Pt electrode layer formed by baking at a high temperature, good adhesion to the conductive intermediate layer can be obtained. Also, in the electrode layer formed of Pt, Pt hardly diffuses, a change in thermistor characteristics is small, and solder leaching is small, so that adhesion of the electrode is maintained even when soldering is performed.

In a thermistor element according to a fifth invention, in any one of the first to fourth inventions, when a content ratio of the Mn to all metal atoms in the conductive intermediate layer is C_{Mn}, 0 at. %<C_{Mn}≤60 at. % is satisfied.

That is, in this thermistor element, when the content ratio of Mn to all metal atoms in the conductive intermediate layer is C_{Mn}, 0 at. %<C_{Mn}≤60 at. % is satisfied, so that good adhesion can be obtained.

In a thermistor element according to a sixth invention, in the second invention, when a content ratio of the Y to all metal atoms in the conductive intermediate layer is C_{Y}, 0 at. %<C_{Y}≤60 at. % is satisfied.

That is, in this thermistor element, when the content ratio of the Y to all metal atoms in the conductive intermediate layer is C_{Y}, 0 at. %<C_{Y}≤60 at. % is satisfied, so that a composite oxide with Mn can be formed to obtain good conductivity.

In a thermistor element according to a seventh invention, in the third invention, the conductive intermediate layer contains one or more of Ca, Sr, Ba, and La at a content ratio to all metal atoms of 0.1 at. % or more.

That is, in this thermistor element, the conductive intermediate layer contains one or more of Ca, Sr, Ba, and La at a content ratio to all metal atoms of 0.1 at. % or more, so that good conductivity can be obtained.

A method for manufacturing a thermistor element according to an eighth invention includes an intermediate layer forming step of forming a conductive intermediate layer of a composite oxide containing Mn on a thermistor element body which contains a thermistor material whose crystal structure is a perovskite-type; and an electrode layer forming step of forming an electrode layer on the conductive intermediate layer, wherein in the intermediate layer forming step, a Mn-containing dispersion containing a powder containing Mn, an organic solvent, and a dispersant is applied onto the thermistor element body, and the Mn-containing dispersion is dried to form a temporary intermediate layer, and in the electrode layer forming step, a Pt paste containing Pt is applied onto the temporary intermediate layer, the Pt paste is fired to form the electrode layer and to make the temporary intermediate layer the conductive intermediate layer.

That is, in this method for manufacturing a thermistor element, in an intermediate layer forming step, a Mn-containing dispersion containing a powder containing Mn, an organic solvent, and a dispersant is applied onto the thermistor element body, and the Mn-containing dispersion is dried to form a temporary intermediate layer, and in an electrode layer forming step, a Pt paste containing Pt is applied onto the temporary intermediate layer, the Pt paste is fired to form an electrode layer and to make the temporary intermediate layer the conductive intermediate layer, so that the Mn of the temporary intermediate layer and the thermistor material of the thermistor element body can be reacted at a high temperature during firing to form a conductive intermediate layer of a composite oxide containing Mn.

In the method for manufacturing a thermistor element according to a ninth invention, in the eighth invention, the Mn-containing dispersion further contains Y.

That is, in this method for manufacturing a thermistor element, since the Mn-containing dispersion further contains Y, it is possible to obtain a conductive intermediate layer of a composite oxide in which Mn and Y are sintered simultaneously with the reaction during firing, or composite oxide particles of Mn and Y are sintered.

In the method for manufacturing a thermistor element according to a tenth invention, in the eighth or ninth invention, the Mn-containing dispersion further contains one or more of Ca, Sr, Ba, and La.

That is, in this method for manufacturing a thermistor element, since the Mn-containing dispersion further contains one or more of Ca, Sr, Ba, and La, it is possible to obtain a conductive intermediate layer of a composite oxide in which Mn and one or more of Ca, Sr, Ba, and La, or Mn and Y and one or more of Ca, Sr, Ba, and La are sintered simultaneously with the reaction during firing, or composite oxide particles of Mn and one or more of Ca, Sr, Ba, and La, or Mn and Y and one or more of Ca, Sr, Ba, and La are sintered.

A method for manufacturing a thermistor element according to an eleventh invention includes an intermediate layer electrode layer forming step of forming a conductive intermediate layer of a composite oxide containing Mn on a thermistor element body which contains a thermistor material whose crystal structure is a perovskite-type, and forming an electrode layer on the conductive intermediate layer, wherein in the intermediate layer electrode layer forming step, a Mn-containing Pt paste containing Mn and Pt is applied onto the thermistor element body, and the Mn-containing Pt paste is fired to form the conductive intermediate layer and the electrode layer.

That is, in this method for manufacturing a thermistor element, in an intermediate layer electrode layer forming step, a Mn-containing Pt paste containing Mn and Pt is applied onto a thermistor element body, and the Mn-containing Pt paste is fired to form a conductive intermediate layer and an electrode layer, so that Mn in the Mn-containing Pt paste diffuses to the thermistor element body side at a high temperature during firing to form the conductive intermediate layer, and the remaining Pt can form the electrode layer.

### Advantageous Effects of Invention

According to the present invention, the following effects are achieved.

That is, according to the thermistor element and the method for manufacturing the same according to the present invention, since the conductive intermediate layer is a composite oxide containing Mn, the crystal structure of the composite oxide containing Mn is close to that of the perovskite-type thermistor element body, so that adhesion of the conductive intermediate layer is improved, and the conductive intermediate layer can stably exist even at a high temperature.

Therefore, an electrode layer of Pt or the like that needs to be baked at a high temperature can be used, and a thermistor element having good adhesion and high reliability can be obtained.

### BRIEF DESCRIPTION OF DRAWINGS

FIG. 1 is a cross-sectional view that illustrates a thermistor element in an embodiment of a thermistor element and a method for manufacturing the same according to the present invention.

FIG. 2 is a cross-sectional view that illustrates a method for manufacturing a thermistor element in the order of steps in the present embodiment.

FIG. 3 is a cross-sectional view that illustrates another method for manufacturing a thermistor element in the order of steps in the present embodiment.

FIG. 4 is an SEM image that illustrates a cross section of a thermistor element in Example 4 of the thermistor element and the method for manufacturing the same according to the present invention.

FIG. 5 is a composition distribution image of La in the cross section of the thermistor element in Example 4 of the present invention.

FIG. 6 is a composition distribution image of Y in the cross section of the thermistor element in Example 4 of the present invention.

FIG. 7 is a composition distribution image of Mn in the cross section of the thermistor element in Example 4 of the present invention.

FIG. 8 is a composition distribution image of Ca in the cross section of the thermistor element in Example 4 of the present invention.

FIG. 9 is an SEM image that illustrates a cross section of a thermistor element in Example 5 of the thermistor element and the method for manufacturing the same according to the present invention.

FIG. 10 is a composition distribution image of Mn in the cross section of the thermistor element in Example 5 of the present invention.

FIG. 11 is a composition distribution image of La in the cross section of the thermistor element in Example 5 of the present invention.

FIG. 12 is a composition distribution image of Y in the cross section of the thermistor element in Example 5 of the present invention.

FIG. 13 is a composition distribution image of Ca in the cross section of the thermistor element in Example 5 of the present invention.

### DESCRIPTION OF EMBODIMENTS

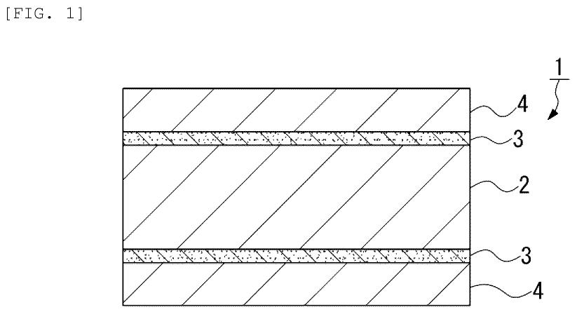

Hereinafter, an embodiment of a thermistor element and a method for manufacturing the same according to the present invention will be described with reference to FIGS. 1 to 3. In each drawing used in the following description, the scale is appropriately changed as necessary to make each member recognizable or easily recognizable in size.

As shown in FIGS. 1 to 3, a thermistor element 1 of the present embodiment includes a thermistor element body 2 which contains an oxide thermistor material whose crystal structure is a perovskite-type, a conductive intermediate layer 3 formed on the thermistor element body 2, and an electrode layer 4 formed on the conductive intermediate layer 3.

The conductive intermediate layer 3 is a composite oxide containing Mn.

In addition, the composite oxide preferably further contains Y (yttrium).

Furthermore, the composite oxide more preferably further contains one or more of Ca, Sr, Ba, and La.

The electrode layer 4 contains Pt. That is, the electrode layer 4 is a Pt electrode obtained by baking a Pt paste.

When the content ratio of Mn to all metal atoms in the conductive intermediate layer 3 is C_{Mn}, 0 at. %<C_{Mn}≤60 at. % is preferably satisfied.

Also, when the content ratio of Y to all metal atoms in the conductive intermediate layer 3 is C_{Y}, 0 at. %<C_{Y}≤60 at. % is preferably satisfied.

Furthermore, the conductive intermediate layer 3 preferably contains one or more of Ca, Sr, Ba, and La at a content ratio to all metal atoms of 0.1 at. % or more. The content ratio of Ca, Sr, Ba, and La is not particularly limited, but may be 10 at. % or less.

The conductive intermediate layer 3 may not be disposed on the entire surface between the thermistor element body 2 and the electrode layer 4, and the conductive intermediate layer 3 may be discontinuously present at a plurality of locations.

The thickness of the conductive intermediate layer 3 is preferably 0.1 to 3 μm.

Also, the B constant of the thermistor element 1 of the present embodiment is, for example, in the range of 1500 to 4000 K.

Furthermore, the resistivity of the thermistor element 1 of the present embodiment is, for example, in the range of 10⁰ to 10⁶ Ωcm.

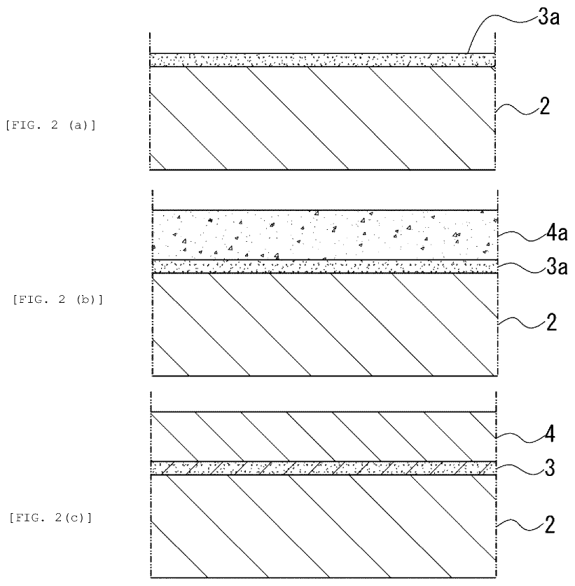

As shown in FIG. 2, a method for manufacturing the thermistor element 1 of the present embodiment includes an intermediate layer forming step of forming a conductive intermediate layer 3 of a composite oxide containing Mn on a thermistor element body 2 which contains a thermistor material whose crystal structure is a perovskite-type, and an electrode layer forming step of forming an electrode layer 4 on the conductive intermediate layer 3.

In the intermediate layer forming step, a Mn-containing dispersion containing a powder containing Mn, an organic solvent, and a dispersant is applied onto the thermistor element body 2, and the Mn-containing dispersion is dried to form the temporary intermediate layer 3a as shown in FIG. 2(a).

In the electrode layer forming step, as shown in FIG. 2(b), a Pt paste containing Pt is applied onto the temporary intermediate layer 3a, and the Pt paste is fired to form the electrode layer 4 and to make the temporary intermediate layer 3a the conductive intermediate layer 3 as shown in FIG. 2(c).

The Mn-containing dispersion preferably further contains Y.

Also, the Mn-containing dispersion more preferably further contains one or more of Ca, Sr, Ba, and La. These may be each oxide, carbonate, or the like since they react with a Mn compound to form a composite oxide with Mn, but since abnormal grain growth may occur during the reaction, they are preferably composite oxides with Mn.

The thermistor element body 2 is obtained by, for example, using a substrate made of various metal oxides and calcium carbonate (CaCO₃) as a sintering accelerator and an electrical characteristic modifier as starting materials, weighing the materials so that each metal has a predetermined molar ratio, mixing these materials and drying and then pre-firing the mixture, followed by molding a mixture with a binder into a plate shape, and firing the molded mixture.

The Mn-containing dispersion is prepared, for example, by weighing a material containing at least Mn so as to have a predetermined molar ratio, mixing a powder obtained by firing with an organic solvent such as ethanol and a dispersant, and then performing a dispersion treatment with a disperser such as a paint shaker.

That is, when one or more powders of Y, Ca, Sr, Ba, and La are contained in addition to Mn, these various metals are weighed so as to have a predetermined molar ratio, and the powder obtained by firing is prepared by mixing and dispersing an organic solvent and a dispersant.

The electrode layer 4 is prepared, for example, by applying a Pt paste by printing and firing the Pt paste. As the baking temperature for this firing is higher, voids generated at the interface between the electrode layer 4 and the conductive intermediate layer 3 are reduced.

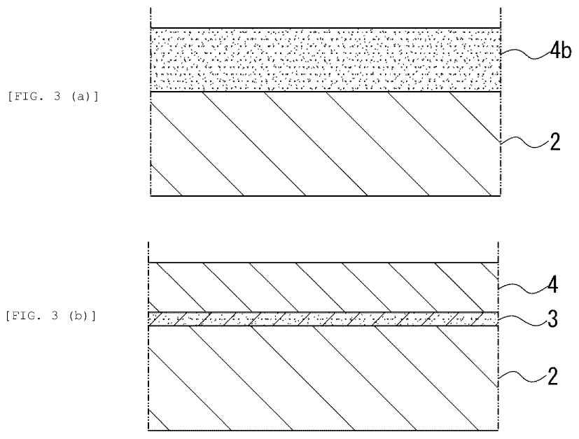

In addition, as shown in FIG. 3, another method for manufacturing the thermistor element 1 of the present embodiment includes an intermediate layer electrode layer forming step of forming a conductive intermediate layer 3 of a composite oxide containing Mn on a thermistor element body 2 which contains a thermistor material whose crystal structure is a perovskite-type, and forming an electrode layer 4 on the conductive intermediate layer 3.

In this intermediate layer electrode layer forming step, a Mn-containing Pt paste 4b containing Mn and Pt is applied onto the thermistor element body 2, and the Mn-containing Pt paste 4b is fired to form the conductive intermediate layer 3 and the electrode layer 4.

The Mn-containing Pt paste 4b is prepared, for example, by adding Mn₂O₃ to the Pt paste.

As described above, in the thermistor element 1 of the present embodiment, since the conductive intermediate layer 3 is a composite oxide containing Mn, the crystal structure of the composite oxide containing Mn is close to that of the perovskite-type thermistor element body 2, so that adhesion between the conductive intermediate layer 3 and the thermistor element body is improved, and the conductive intermediate layer 3 can stably exist even at a high temperature. In particular, since the conductive intermediate layer 3 contains Mn, high adhesion to the electrode layer 4 formed of a noble metal can be obtained, and even when the electrode layer 4 is formed of a noble metal or the like that needs to be baked at a high temperature, the conductive intermediate layer 3 can stably exist even after baking. In addition, since the oxide thermistor material constituting the thermistor element body 2 contains an oxide containing Mn, the adhesion to the conductive intermediate layer 3 which is a composite oxide containing Mn is further improved.

Therefore, even when the electrode layer 4 of Pt is formed by baking at a high temperature, good adhesion to the conductive intermediate layer 3 can be obtained. Also, in the electrode layer 4 formed of Pt, Pt hardly diffuses, a change in thermistor characteristics is small, and solder leaching is small, so that adhesion of the electrode is maintained even when soldering is performed.

Moreover, since the formed intermediate layer contains Y, higher conductivity can be obtained by reacting Mn and Y during the heat treatment to form a composite oxide and simultaneously sintering the composite oxide, or sintering the Mn compound already formed into a composite oxide with Y. Since the oxide thermistor material constituting the thermistor element body 2 contains an oxide containing Y, the adhesion to the conductive intermediate layer 3 containing Y is further improved.

Furthermore, since the composite oxide further contains one or more of Ca, Sr, Ba, and La, the substitution of Y in the composite oxide with at least one of Ca, Sr, Ba, and La reduces lattice distortion to improve electron mobility in the case of La, and increases carriers in the cases of Ca, Sr, and Ba, so that high conductivity can be obtained.

When the content ratio of Mn to all metal atoms in the conductive intermediate layer 3 is C_{Mn}, 0 at. %<C_{Mn}≤60 at. % is satisfied, so that good adhesion can be obtained.

Furthermore, when the content ratio of Y to all metal atoms in the conductive intermediate layer 3 is C_{Y}, 0 at. %<C_{Y}≤60 at. % is satisfied, so that a composite oxide with Mn can be formed to obtain good conductivity.

Furthermore, the conductive intermediate layer 3 contains one or more of Ca, Sr, Ba, and La at a content ratio to all metal atoms of 0.1 at. % or more, so that good conductivity can be obtained.

In the method for manufacturing the thermistor element 1 of the present embodiment, in an intermediate layer forming step, a Mn-containing dispersion containing a powder containing Mn, an organic solvent, and a dispersant is applied onto the thermistor element body 2, and the Mn-containing dispersion is dried to form a temporary intermediate layer 3a, and in an electrode layer forming step, a Pt paste containing Pt is applied onto the temporary intermediate layer 3a, the Pt paste is fired to form an electrode layer 4 and to make the temporary intermediate layer 3a the conductive intermediate layer 3, so that the Mn of the temporary intermediate layer 3a and the thermistor material of the thermistor element body 2 can be reacted at a high temperature during firing to form the conductive intermediate layer 3 of a composite oxide containing Mn.

In addition, since the Mn-containing dispersion further contains Y, it is possible to obtain the conductive intermediate layer 3 of a composite oxide obtained by reacting Mn and Y during firing.

Furthermore, since the Mn-containing dispersion further contains one or more of Ca, Sr, Ba, and La, it is possible to obtain the conductive intermediate layer 3 of the composite oxide in which Mn and one or more of Ca, Sr, Ba, and La, or Mn and Y and one or more of Ca, Sr, Ba, and La are sintered simultaneously with the reaction during firing, or composite oxide particles of Mn and one or more of Ca, Sr, Ba, and La, or Mn and Y and one or more of Ca, Sr, Ba, and La are sintered.

In another method for manufacturing the thermistor element 1 of the present embodiment, in an intermediate layer electrode layer forming step, a Mn-containing Pt paste 3b containing Mn and Pt is applied onto a thermistor element body 2, and the Mn-containing Pt paste 3b is fired to form a conductive intermediate layer 3 and an electrode layer 4, so that Mn in the Mn-containing Pt paste 3b diffuses to the thermistor element body 2 side at a high temperature during firing to form the conductive intermediate layer 3, and the remaining Pt can form the electrode layer 4.

### EXAMPLES

### Example 1

First, using a substrate made of commercially available yttrium oxide (Y₂O₃), chromium oxide (Cr₂O₃) and manganese carbonate (MnCO₃), and calcium carbonate (CaCO₃) as a sintering accelerator and an electrical characteristic modifier as starting materials, the materials were weighed so that the molar ratio of Y:Cr:Mn:Ca was 79.5:8.5:8.5:3.5. These weighed materials were mixed in a wet ball mill, dried and then pre-fired at 1000° C. for 5 hours, followed by mixing with 1.5 wt % of polyvinyl alcohol as a binder. This powder was molded into a plate shape with a thickness of 1 mm by uniaxial pressure molding. The molded powder was fired at 1500° C. for 24 hours to obtain a plate material, and both surfaces thereof were polished to prepare a wafer with a thickness of 0.4 mm to be a thermistor element body.

Next, as conductive intermediate layer materials, the materials were weighed so that the molar ratio of Y:La:Sr:Mn was 3:6:1:10, and fired at 1200° C. for 5 hours. The resulting powder was roughly pulverized in a mortar, and then a 20 wt. % ethanol dispersion (Mn-containing dispersion) was prepared by a paint shaker using SC-0505K manufactured by NOF CORPORATION as a dispersant. This dispersion was applied to both surfaces of the prepared wafer by dip coating, and dried to form a conductive intermediate layer. This conductive intermediate layer is a composite oxide of Mn, Y, La, and Sr. Thereafter, a Pt paste was applied by printing and fired at 1300° C. to form an electrode layer. Furthermore, thereafter, a chip-shaped thermistor element of 0.5 mm×0.5 mm was obtained by dicing.

In Example 1, the 3 CV (coefficient of variation) indicating the variation in resistance values of twenty thermistor elements measured at 25° C. was 4.4%. As a result of observing the cross section of the thermistor element with TEM-EDS, a conductive intermediate layer of 0.1 μm was observed in the average of five observed fields, and the composition was Mn: 48 at. %, Y: 17 at. %, La: 31 at. %, and Sr: 5 at. %.

### Example 2

A Pt paste (Mn-containing Pt paste) in which Mn₂O₃ was added in an amount of 5 wt. % relative to Pt (platinum) was applied to both surfaces of the wafer (thermistor element body) prepared in Example 1 by printing, and fired at 1400° C. to form an electrode layer and simultaneously form a conductive intermediate layer. This conductive intermediate layer is a composite oxide containing elements Y and Ca diffused from the thermistor element body in addition to Mn. Thereafter, a chip-shaped thermistor element of 0.5 mm×0.5 mm was obtained by dicing.

In Example 2, the 3 CV indicating the variation in resistance values of twenty thermistor elements measured at 25° C. was 4.9%. As a result of observing the element cross section with TEM-EDS, a conductive intermediate layer of 3 μm was observed in the average of five observed fields, and the composition was Mn: 44 at. %, Y: 54 at. %, and Ca: 2 at. %.

### Example 3

Using a substrate made of commercially available lanthanum oxide (La₂O₃), chromium oxide (Cr₂O₃) and manganese carbonate (MnCO₃), and calcium carbonate (CaCO₃) as a sintering accelerator and an electrical characteristic modifier as starting materials, the materials were weighed so that the molar ratio of La:Cr:Mn:Ca was 7:6:4:3. These weighed materials were mixed in a wet ball mill, dried, and then pre-fired at 1300° C. for 5 hours. Since La₂O₃ reacts with moisture in the air to be easily converted into hydroxide, La₂O₃ was weighed within 3 hours after heating at 1000° C. for 2 hours. The calcined powder was roughly pulverized in a mortar, and then a commercially available yttrium oxide (Y₂O₃) was weighed so that Y was twice as much as La in terms of molar ratio, and mixed in a wet ball mill. Thereafter, the mixture was dried, and 1.5 wt. % of the powder was mixed with polyvinyl alcohol as a binder. This powder was molded into a plate shape with a thickness of 1 mm by uniaxial pressure molding. The molded powder was fired at 1600° C. for 24 hours to obtain a plate material, and both surfaces thereof were polished to prepare a wafer with a thickness of 0.4 mm to be a thermistor element body.

Next, as conductive intermediate layer materials, the materials were weighed so that the molar ratio of Y:La:Ca:Mn was 1:7:2:10, and fired at 1200° C. for 5 hours. The resulting powder was roughly pulverized in a mortar, and then a 20 wt. % ethanol dispersion (Mn-containing dispersion) was prepared by a paint shaker using SC-0505K manufactured by NOF CORPORATION as a dispersant. This dispersion was applied to both surfaces of the prepared wafer (thermistor element body) by dip coating, and dried to form a conductive intermediate layer. This conductive intermediate layer is a composite oxide of Mn, Y, La, and Ca. Thereafter, a Pt paste was applied by printing and fired at 1300° C. to form an electrode layer. Furthermore, thereafter, a chip-shaped thermistor element of 0.5 mm×0.5 mm was obtained by dicing.

In Example 3, the 3 CV indicating the variation in resistance values of twenty thermistor elements measured at 25° C. was 1.3%. As a result of observing the element cross section with TEM-EDS, an intermediate layer of 1.2 μm was observed in the average of five observed fields, and the composition was Mn: 50 at. %, Y: 6 at. %, La: 35 at. %, and Ca: 9 at. %.

### Example 4

A Pt paste (Mn-containing Pt paste) in which Mn₂O₃ was added in an amount of 1 wt. % relative to Pt was applied to both surfaces of the wafer (thermistor element body) prepared in Example 3 by printing, and fired at 1300° C. to form an electrode layer and simultaneously form a conductive intermediate layer. This conductive intermediate layer is a composite oxide containing elements Y, La, and Ca diffused from the thermistor element body in addition to Mn. Thereafter, a chip-shaped thermistor element of 0.5 mm×0.5 mm was obtained by dicing.

In Example 4, the 3 CV indicating the variation in resistance values of twenty thermistor elements measured at 25° C. was 3.8%. As a result of observing the element cross section with TEM-EDS, a conductive intermediate layer of 0.5 μm was observed in the average of five observed fields, and the composition was Mn: 47 at. %, Y: 52 at. %, and La: 1 at. %.

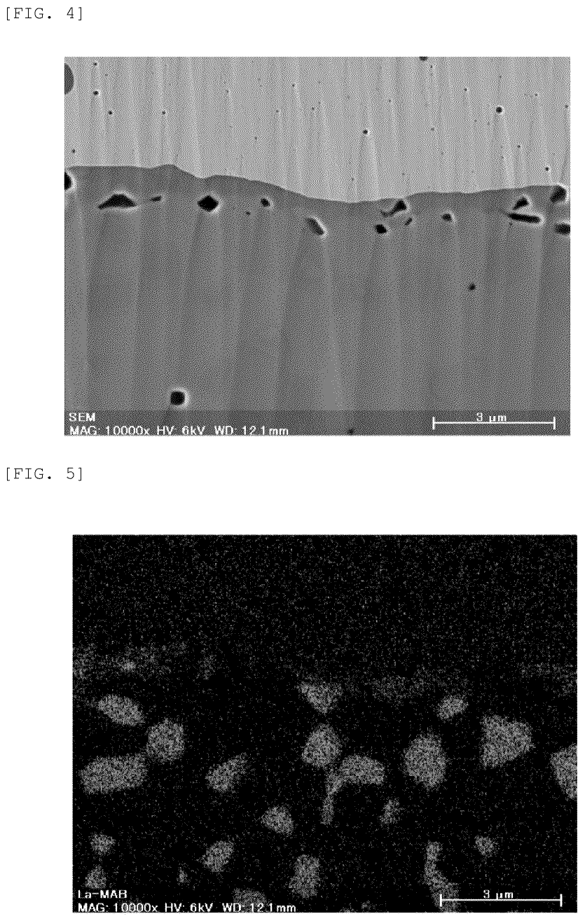

FIG. 4 shows an SEM image that illustrates a cross section of the thermistor element in Example 4.

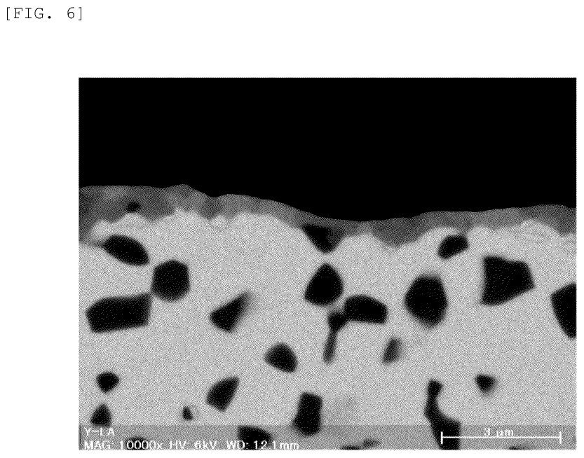

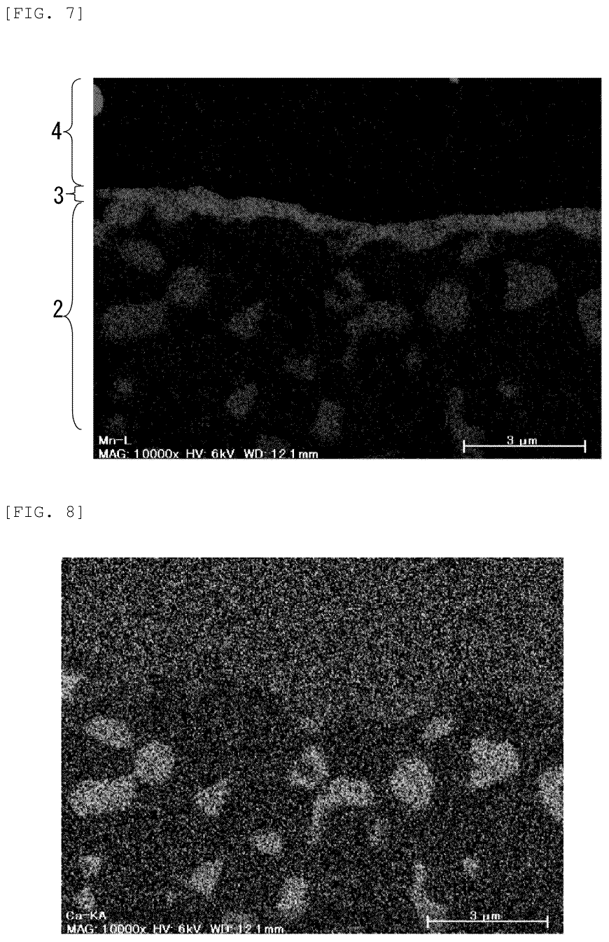

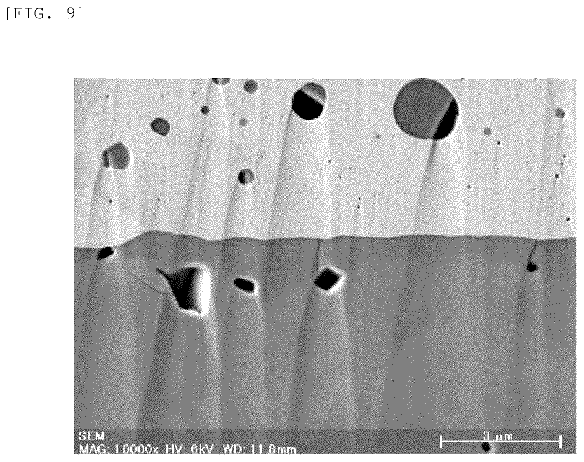

In addition, composition distribution images of each of La, Y, Mn, and Ca in the cross section of the thermistor element in Example 4 are shown in FIGS. 5 to 8.

### Example 5

A Pt paste (Mn-containing Pt paste) in which Mn₂O₃ was added in an amount of 1 wt. % relative to Pt was applied to both surfaces of the wafer prepared in Example 3 by printing, and fired at 1400° C. to form an electrode layer and simultaneously form a conductive intermediate layer. This conductive intermediate layer is a composite oxide containing elements Y, La, and Ca diffused from the thermistor element body in addition to Mn. Thereafter, a chip-shaped thermistor element of 0.5 mm×0.5 mm was obtained by dicing.

In Example 5, the 3 CV indicating the variation in resistance values of twenty thermistor elements measured at 25° C. was 2.5%. As a result of observing the element cross section with TEM-EDS, an intermediate layer of 0.7 μm was observed in the average of five observed fields, and the composition was Mn: 43 at. %, Y: 46 at. %, La: 6 at. %, Ca: 1 at. %, and Cr: 4 at. %.

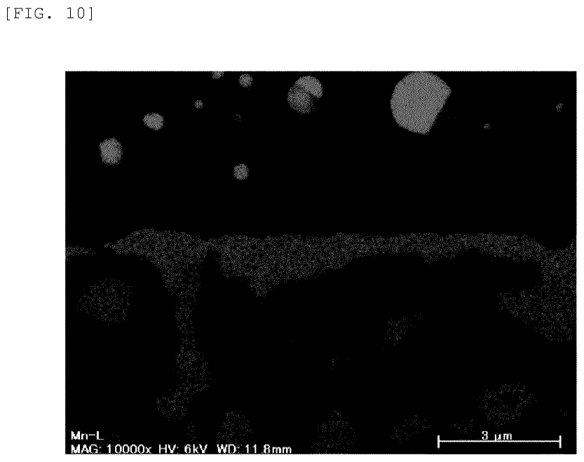

FIG. 9 shows an SEM image that illustrates a cross section of the thermistor element in Example 5.

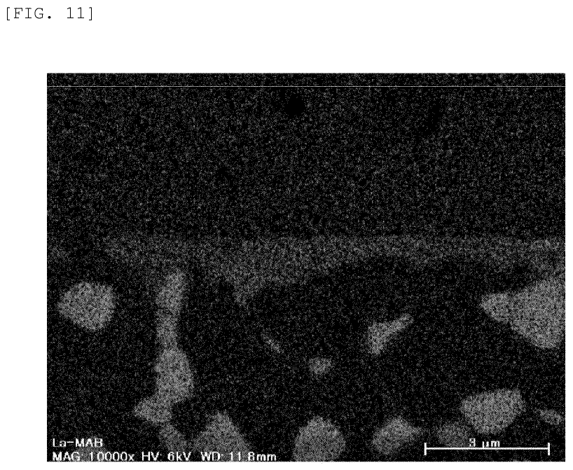

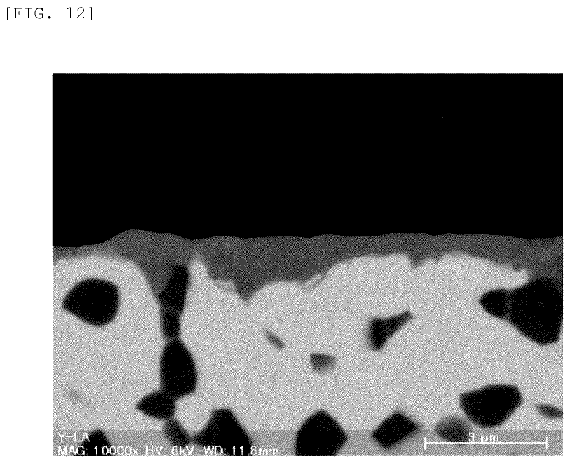

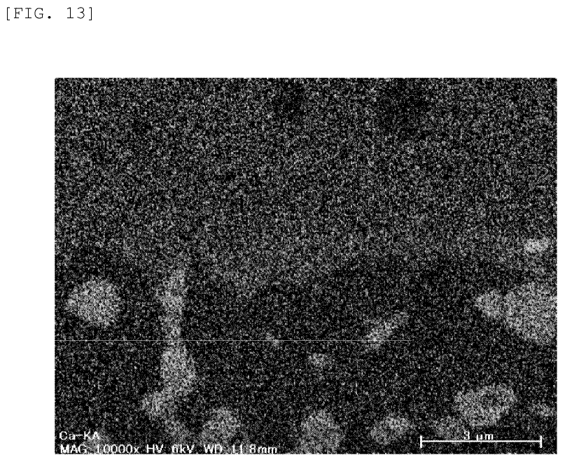

In addition, composition distribution images of each of Mn, La, Y, and Ca in the cross section of the thermistor element in Example 5 are shown in FIGS. 10 to 13.

### Example 6

As conductive intermediate layer materials, the materials were weighed so that the molar ratio of Y:La:Ba:Mn was 2:7:1:10, and fired at 1200° C. for 5 hours. The resulting powder was roughly pulverized in a mortar, and then a 20 wt. % ethanol dispersion (Mn-containing dispersion) was prepared by a paint shaker using SC-0505K manufactured by NOF CORPORATION as a dispersant. This dispersion was applied to both surfaces of the wafer prepared in Example 3 by dip coating, and dried to form a conductive intermediate layer. This conductive intermediate layer is a composite oxide of Mn, Y, La, and Ca. Thereafter, a Pt paste was applied by printing and fired at 1300° C. to form an electrode layer. Furthermore, thereafter, a chip-shaped thermistor element of 0.5 mm×0.5 mm was obtained by dicing.

In Example 6, the 3 CV indicating the variation in resistance values of twenty thermistor elements measured at 25° C. was 1.8%. As a result of observing the element cross section with TEM-EDS, an intermediate layer of 0.8 μm was observed in the average of five observed fields, and the composition was Mn: 48 at. %, Y: 11 at. %, La: 34 at. %, Ba: 4 at. %, and Cr: 4 at. %.

### Comparative Example 1

A thermistor element was prepared in the same manner as in Example 1 except that no intermediate layer was formed on the wafer (thermistor element body) prepared in Example 1.

In Comparative Example 1, the 3 CV indicating the variation in resistance values of twenty thermistor chips measured at 25° C. was 7.8%.

Table 1 shows results of evaluating the intermediate layer composition, the intermediate layer forming method, and the resistance value variation (3 CV) for each of Examples and Comparative Examples of the present invention.

TABLE 1

| | Element preparation | | Evaluation |
|---|---|---|---|
| | Intermediate | Intermediate layer | Variation |
| | layer composition | forming method | (3 CV) |
| Example 1 | Mm: 48 at. % | Dip coating | 4.4% |
| | Y: 17 at. % | | |
| | La: 31 at. % | | |
| | Sr: 5 at. % | | |
| Example 2 | Mn: 44 at. % | Containing Mn2O3 | 4.9% |
| | Y: 54 at. % | in paste | |
| | Ca: 2 at. % | Thermal diffusion | |
| Example 3 | Mn: 50 at. % | Dip coating | 1.3% |
| | Y: 6 at. % | | |
| | La: 35 at. % | | |
| | Ca: 9 at. % | | |
| Example 4 | Mn: 47 at. % | Containing Mn2O3 | 3.8% |
| | Y: 52 at. % | in paste | |
| | La: 1 at. % | Thermal diffusion | |
| Example 5 | Mn: 43 at. % | Containing Mn2O3 | 2.5% |
| | Y: 46 at. % | in paste | |
| | La: 6 at. % | Thermal diffusion | |
| | Ca: 1 at. % | | |
| | Cr: 4 at. 5% | | |
| Example 6 | Mn: 48 at. % | Dip coating | 1.8% |
| | Y: 11 at. % | | |
| | La: 34 at. % | | |
| | Ba: 4 at. % | | |
| | Cr: 4 at. % | | |
| Comparative | — | — | 7.8% |
| Example 1 | | | |

From these evaluation results, it can be seen that the resistance value variation (3 CV) is as large as 7.8% in Comparative Example 1, whereas it is as small as 4.9% or less in all Examples of the present invention. As described above, in Examples of the present invention, it can be seen that the Pt paste or the Mn-containing Pt paste can be baked, and the adhesion of the conductive intermediate layer is improved to have high conductivity.

In Examples 2, 4, and 5, the conductive intermediate layer composition contains Y, La, and Ca, which are obtained by thermal diffusion of Y, La, and Ca from the thermistor element body into the conductive intermediate layer during firing.

The technical scope of the present invention is not limited to the above embodiments and the above examples, and various modifications can be made without departing from the gist of the present invention.

### REFERENCE SIGNS LIST

1 Thermistor element
2 Thermistor element body
3 Conductive intermediate layer
3a Temporary intermediate layer
4 Electrode layer
4a Pt paste
4b Mn-containing Pt paste

1. A thermistor element comprising:
a thermistor element body which contains an oxide thermistor material whose crystal structure is a perovskite-type;
a conductive intermediate layer formed on the thermistor element body; and
an electrode layer formed on the conductive intermediate layer, wherein
the conductive intermediate layer is a composite oxide containing Mn.

2. The thermistor element according to claim 1, wherein
the composite oxide further contains Y.

3. The thermistor element according to claim 1, wherein
the composite oxide further contains one or more of Ca, Sr, Ba, and La.

4. The thermistor element according to claim 1, wherein
the electrode layer contains Pt.

5. The thermistor element according to claim 1, wherein
when a content ratio of the Mn to all metal atoms in the conductive intermediate layer is C_{Mn}, 0 at. %<C_{Mn}≤60 at. % is satisfied.

6. The thermistor element according to claim 2, wherein
when a content ratio of the Y to all metal atoms in the conductive intermediate layer is C_{Y}, 0 at. %<C_{Y}≤60 at. % is satisfied.

7. The thermistor element according to claim 3, wherein
the conductive intermediate layer contains one or more of Ca, Sr, Ba, and La at a content ratio to all metal atoms of 0.1 at. % or more.

8. A method for manufacturing a thermistor element, comprising:
an intermediate layer forming step of forming a conductive intermediate layer of a composite oxide containing Mn on a thermistor element body which contains a thermistor material whose crystal structure is a perovskite-type; and
an electrode layer forming step of forming an electrode layer on the conductive intermediate layer, wherein
in the intermediate layer forming step, a Mn-containing dispersion containing a powder containing Mn, an organic solvent, and a dispersant is applied onto the thermistor element body, and the Mn-containing dispersion is dried to form a temporary intermediate layer, and
in the electrode layer forming step, a Pt paste containing Pt is applied onto the temporary intermediate layer, the Pt paste is fired to form the electrode layer and to make the temporary intermediate layer the conductive intermediate layer.

9. The method for manufacturing a thermistor element according to claim 8, wherein
the Mn-containing dispersion further contains Y.

10. The method for manufacturing a thermistor element according to claim 8, wherein
the Mn-containing dispersion further contains one or more of Ca, Sr, Ba, and La.

11. A method for manufacturing a thermistor element, comprising:
an intermediate layer electrode layer forming step of forming a conductive intermediate layer of a composite oxide containing Mn on a thermistor element body which contains a thermistor material whose crystal structure is a perovskite-type, and forming an electrode layer on the conductive intermediate layer, wherein
in the intermediate layer electrode layer forming step, a Mn-containing Pt paste containing Mn and Pt is applied onto the thermistor element body, and the Mn-containing Pt paste is fired to form the conductive intermediate layer and the electrode layer.
